(19) United States
(12) Patent Application Publication
(10) Pub. No.: US 2007/0175211 A1
(43) Pub. Date: Aug. 2, 2007

(54) Release system, particularly for releasing hydraulic actuators for automatic openings

(75) Inventor: Fabrizio Di Saverio, San Nicolo' (TE) (IT)

Correspondence Address: YOUNG & THOMPSON, 745 SOUTH 23RD STREET, 2ND FLOOR, ARLINGTON, VA, 22202, US

(73) Assignee: FINDISA S.R.L., SAN NICOLO' (TE) (IT)

(21) Appl. No.: 11/654,511

(22) Filed: Jan. 18, 2007

(30) Foreign Application Priority Data
Jan. 27, 2006 (IT) RM2006A000042

(51) Int. Cl. F16D 31/02

(52) U.S. Cl. 60/476

(57) ABSTRACT

A release system, particularly for releasing hydraulic actuators for automatic openings having an articulated arm for swing-door gates, provided in a hydraulic circuit having a hydraulic pump (3), operated by a reversible motor, two cylinder-piston elements (6, 7), alternatively receiving hydraulic liquid (L) from the hydraulic pump (3) through two tubes (4, 5), a valve (9, 10) being provided along the tubes (4, 5), between each cylinder-piston element (6, 7) and the hydraulic pump (3), preventing the return of the hydraulic liquid toward the hydraulic pump (3), the return being permitted only by an inverse rotation of the pump (3) operation motor, the system being characterized in that a normally closed manual opening-closing elements (11) being provided along the tubes (6, 7), connected in parallel with respect to the pump (3).

The present invention relates to a release system, particularly for releasing hydraulic actuators for automatic openings.

More specifically, the invention relates to a system of the above kind permitting to the operator of acting manually on the gate, or similar device, even in absence of power supply or in case of motor failures.

Furthermore, the solution suggested according to the invention permits using hydraulic operation systems for opening articulated arms.

As it is well known, a gate provided with operator having articulated arm and no lock, in case of failure of the motor/lack of power supply, would remain blocked not permitting any kind of manual opening.

It is further known that the use of hydraulic opening devices for articulated arm-opening systems was not used.

The solution suggested according to the present invention instead permits using this kind of hydraulic technology for operator having articulated arm.

Thus, the object of the present invention is that of solving the problem of manoeuvring the gate, or other device, in case of lack of power supply, occurrence that would be otherwise particularly serious in some countries where specific rules provide that gate manoeuvrability is always ensured.

It is therefore specific object of the present invention a release system, particularly for releasing hydraulic actuators for automatic openings having an articulated arm for swing-door gates, provided in a hydraulic circuit having a hydraulic pump, operated by a reversible motor, two cylinder-piston elements, alternatively receiving hydraulic liquid from said hydraulic pump through two tubes, a valve being provided along said tubes, between each cylinder-piston element and the hydraulic pump, preventing the return of the hydraulic liquid toward the hydraulic pump, said return being permitted only by a inverse rotation of the pump operation motor, said system being characterised in that, a normally closed manual opening-closing means is provided along said tubes, connected in parallel with respect to said pump.

Preferably, according to the invention, said normally closed manual opening-closing means is comprised of a manual cock.

Always according to the invention, said normally closed manual opening-closing means is provided in a protected position.

Particularly, said normally closed manual opening-closing means can be provided within a housing having a door that can be open by lock or other system permitting its opening only by authorised personnel.

The present invention will be now described, for illustrative but not limitative purposes, according to its preferred embodiments, with particular reference to the figures of the enclosed drawings, wherein:

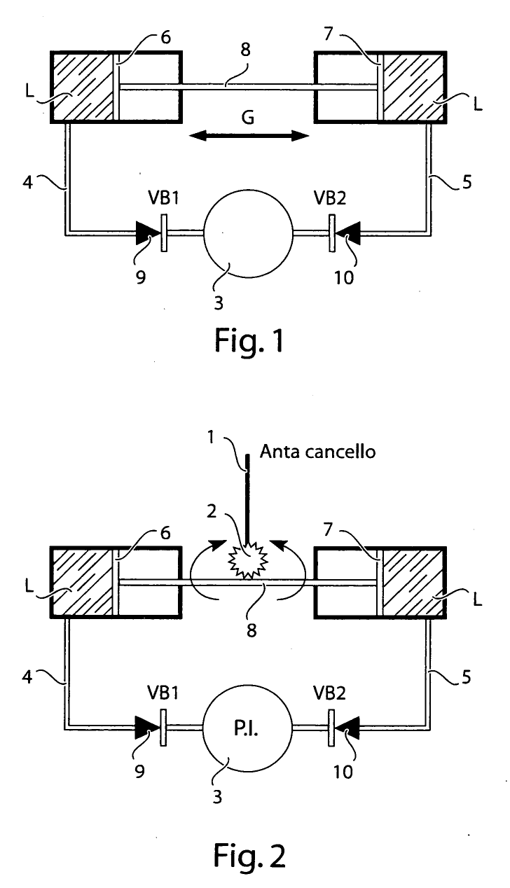

FIG. 1 schematically shows a hydraulic circuit according to the prior art;

FIG. 2 is a second schematic view of a hydraulic circuit according to the prior art;

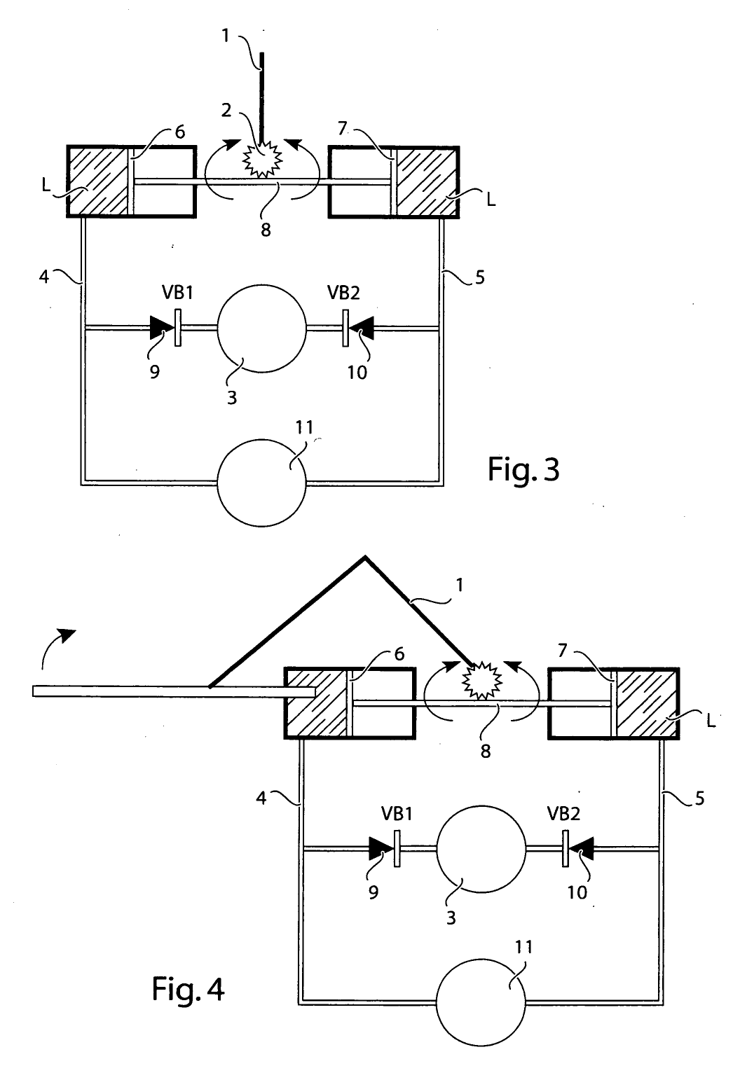

FIG. 3 schematically shows a hydraulic circuit with the device according to the invention; and

FIG. 4 is a second schematic view of a hydraulic circuit with the device according to the invention.

Observing first FIGS. 1 and 2 of the drawings, it is shown a hydraulic circuit according to the prior art, applied for example to the articulated arm operation system for a gate 1, by a pinion gear 2 (see particularly FIG. 2).

Hydraulic circuit shown in the drawings provides a hydraulic pump 3, operated by a reversible motor (not shown) sending hydraulic liquid L through tubes 4, 5, to two cylinders 6, 7, thus exerting a pressure toward one of the two cylinders 6, 7, and thus a linear movement of rod 8.

Check valves 9, 10 are provided on tubes 4, 5, between hydraulic pump 3 and two pistons 6, 7, respectively, realised in such a way to prevent return of hydraulic liquid L in the opposite direction (i.e. from cylinder 6 or 7 toward pump 3).

Consequently, rod 8 cursor, to which toothed wheel 2 is coupled, cannot be moved by outside forces applied on gate 1.

Only a rotation of motor, and thus pump 3, can transfer hydraulic liquid L from first to second chamber of cylinders 6, 7, or vice versa.

As it an be observed from FIG. 2, hydraulic circuit can substantially open or close gate 1 acting on operator having articulated arm. In fact, due to the presence of lock 9, 10 valves, gate 1 is forced to remain in position obtained by rotation of motor, so that, in case of lack of power supply, and lacking an alternative power supply, gate 1 cannot be manoeuvred. Solution suggested according to the present invention permits solving the problem of manoeuvring the operator having articulated arm in case of lack of power supply.

When describing the inventive solution, the same reference numbers will indicate parts corresponding to those shown in FIGS. 1-2.

As it can be observed in FIGS. 3-4 ,inventive solution provides, connected in parallel with respect to hydraulic pump 3, on tubes 4, 5, a manual cock, which is normally closed.

In case of lack of power supply, or in case of any other blocking of the hydraulic circuit, it is possible, by cock 11, manually acting on the same.

Opening cock 11, hydraulic circuit is open, thus permitting circulation of liquid 1 from one side to the other.

Consequently, a force applied outside the gate 1 can make rotating the pin of the same gate 1, since the system has been substantially transformed from irreversible into reversible.

Advantageously, cock 11 will be in a protected position that can be reached only by an authorised operator.

As it is evident, the solution described can be advantageously applied to motion of swing-door gates by operator having articulated arm, wherein it is now not provided a release mechanism for the hydraulic devices.

By the solution suggested according to the present invention, it is possible for the operator manually acting on the operator having articulated arm for a gate even if the power supply lacks or in case of motor failure.

Further, by the inventive solution, it is possible using hydraulic operators for opening an operator having articulated arm, now not possible with known solutions just because the hydraulic system does not provide a release system.

A gate with operator having articulated arm, in case of motor failure of in case of lack of power supply, would remain blocked not permitting a manual opening, problem solved by the inventive solution permitting the application of the hydraulic technology to articulated arms.

A further safety factor is due to the fact that the release cock is protected by a door or other kind of protection, so that every kind of operation of the same is possible only to authorised personnel.

1. Release system, particularly for releasing hydraulic actuators for automatic openings having an articulated arm for swing-door gates, provided in a hydraulic circuit having a hydraulic pump, operated by a reversible motor, two cylinder-piston elements, alternatively receiving hydraulic liquid from said hydraulic pump through two tubes, a valve being provided along said tubes, between each cylinder-piston element and the hydraulic pump, preventing the return of the hydraulic liquid toward the hydraulic pump, said return being permitted only by a inverse rotation of the pump operation motor, said system being characterised in that, a normally closed manual opening-closing means is provided along said tubes, connected in parallel with respect to said pump.

2. Release system, particularly for releasing hydraulic actuators for automatic openings according to claim 1, characterised in that said normally closed manual opening-closing means is comprised of a manual cock.

3. Release system, particularly for releasing hydraulic actuators for automatic openings according to claim 1, characterised in that said normally closed manual opening-closing means is provided in a protected position.

4. Release system, particularly for releasing hydraulic actuators for automatic openings according to claim 3, characterised in that said normally closed manual opening-closing means is provided within a housing having a door that can be open by lock or other system permitting its opening only by authorised personnel.

5. Release system, particularly for releasing hydraulic actuators for automatic openings according to claim 2 characterised in that said normally closed manual opening-closing means is provided in a protected position.
